(19) United States
(12) Patent Application Publication
(10) Pub. No.: US 2003/0112360 A1
(43) Pub. Date: Jun. 19, 2003

(54) Testing device for automatic exposure function of digital camera

(76) Inventors: Fang-Yu Liao, Shinjuang City (TW); Ying-Hao Hsu, Kaohsiung (TW); Jih-Yung Lu, Sanchung City (TW)

Correspondence Address: SNELL & WILMER, ONE ARIZONA CENTER, 400 EAST VAN BUREN, PHOENIX, AZ, 850040001

(21) Appl. No.: 10/314,771

(22) Filed: Dec. 9, 2002

(30) Foreign Application Priority Data
Dec. 19, 2001 (TW) 090131450

(51) Int. Cl. H04N 5/235

(52) U.S. Cl. 348/362

(57) ABSTRACT

The present invention provides a testing device for testing an automatic exposure function of a digital camera. The testing device includes a holding device, a light box, and an optical module. The holding device is used for holding the digital camera. The light box is used for providing a light source. The optical module is disposed between the holding device and the light box for changing a light intensity of light source projected onto the camera. The optical module includes a rotation device. A driving device is used for driving the rotation device to rotate, and a plurality of optical lenses with different light transmission rate are disposed on the rotation device.

### CROSS REFERENCE TO RELATED APPLICATIONS

This application claims priority to Taiwan Patent Application No. 090131450 entitled “Testing Device for Automatic Exposure Function of Digital Camera”, filed Dec. 19, 2001.

### FIELD OF INVENTION

The present invention relates to a testing device and, particularly, to a testing device for an automatic exposure function of a digital camera.

### BACKGROUND OF THE INVENTION

A digital camera captures analog images by a light-sensing device, such as a charge coupled device (CCD), a CMOS image sensor, or the like, converts the analog signal into digital signal by an analog-to-digital converter (ADC), compresses digital signal by a digital signal processor, and stores the digital signal in a memory. In this way, the digital camera does not need film for development of the images. Furthermore, by utilizing various digital image processing techniques and apparatus, users can easily edit, modify, transmit, or output digital images on various monitors.

Generally, a digital camera has an automatic exposure function which detects luminance variation of the environment and promptly adjusts the exposure mechanism (e.g. a shutter, an aperture, or the like) of digital camera to provide an appropriate exposure value. Additionally, the automatic exposure function further performs exposure compensation under a gloomy environment (e.g. under a back-light or a dim environment).

Therefore, a digital camera manufacturer tests the automatic exposure function before shipping out digital camera, so as to assure that the digital camera can capture images with consistent luminance effect under different intensity of light source.

In one prior art technology, a light box provides a background light source for testing automatic exposure function. By varying the intensity of light box, whether consistent-brightness images are captured under different intensity of light source or not can be concluded.

However, the light box usually varies the intensity by controlling voltage or current. However, with this approach, the variation range of intensity is limited. Thus, multiple sets of light boxes are required in the prior alt.

### OBJECTS AND SUMMARY OF THE INVENTION

It is therefore an aspect of the present invention to provide a testing device for testing an automatic exposure function of a digital camera by using single light box.

The present invention provides a testing device for testing an automatic exposure function of a digital camera. The testing device includes a holding device for holding the digital camera, a light box for providing a light source, and an optical module disposed between the holding device and the light box for changing the intensity of light projected onto the camera. The optical module includes a rotation device. A driving device drives the rotation device to rotate, and a plurality of optical lenses with different light transmission rate are disposed along a circumferential direction of the rotation device.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a side view of a testing device performing testing in accordance with the present invention;

FIG. 2 is a top view of the testing device performing testing in accordance with the present invention;

FIG. 3 is a schematic diagram of an optical module in accordance with the present invention.

### DETAILED DESCRIPTION OF THE INVENTION

The present invention provides a testing device for testing an automatic exposure function of a digital camera and for providing various light intensities of light source. In contrast to the prior art where multiple light boxes are required for providing various intensities of light source when testing automatic exposure function, the present invention only requires single light box to provide various intensities of light source. Therefore, the testing device of the present invention occupies less space, and the adjustment in the intensity of light box is flexible with the design of the optical module.

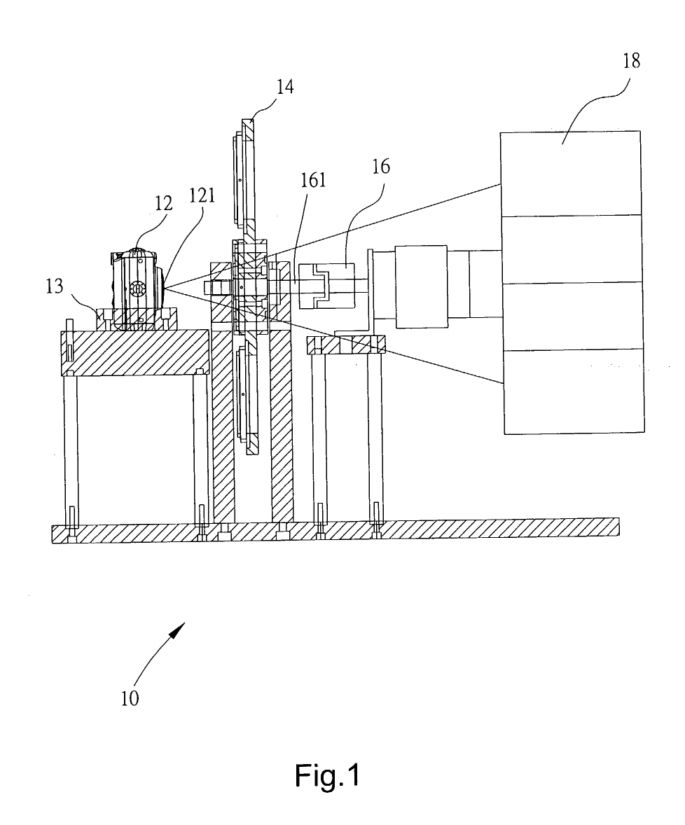

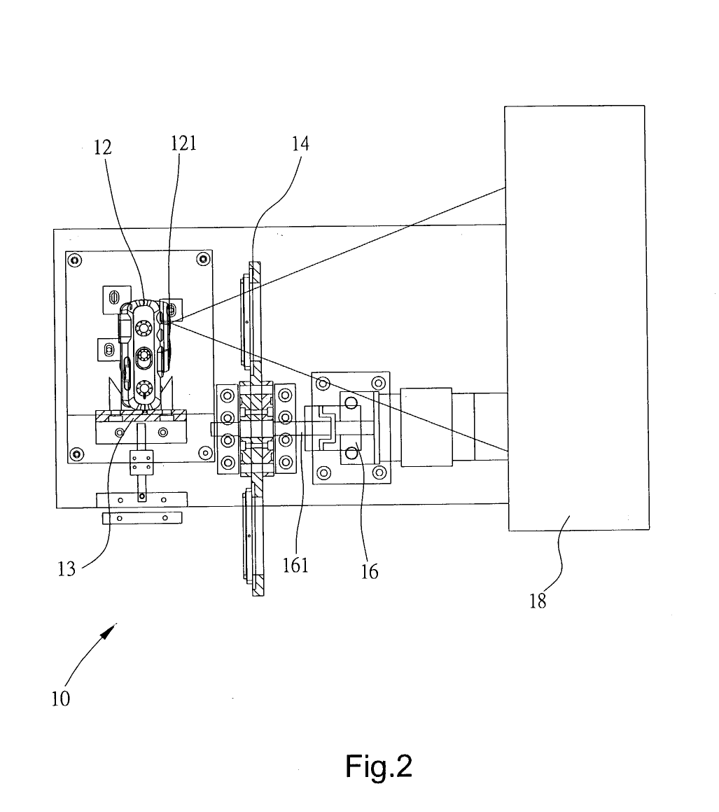

Please refer to FIG. 1 and FIG. 2. The testing device 10 of the present invention includes a holding device 13, an optical module 14, a driving device 16, a pivot 161, and a light box 18.

The holding device 13 is configured to hold a digital camera 12 in a process of testing automatic exposure function. The light box 18 is configured to provide a light source required when the automatic exposure function is tested. In this embodiment, the light box 18 may be identical with the light box of the prior alt. The optical module 14 is disposed between the holding device 13 and the light box 18 for changing the intensity of light from the light box 18 projected onto lens 121 of the digital camera 12. The driving device 16 is connected to the optical module 14 via the pivot 161, so as to drive the optical module 14 to rotate. In this embodiment, the driving device 16 is a servomotor, but is not limited to that.

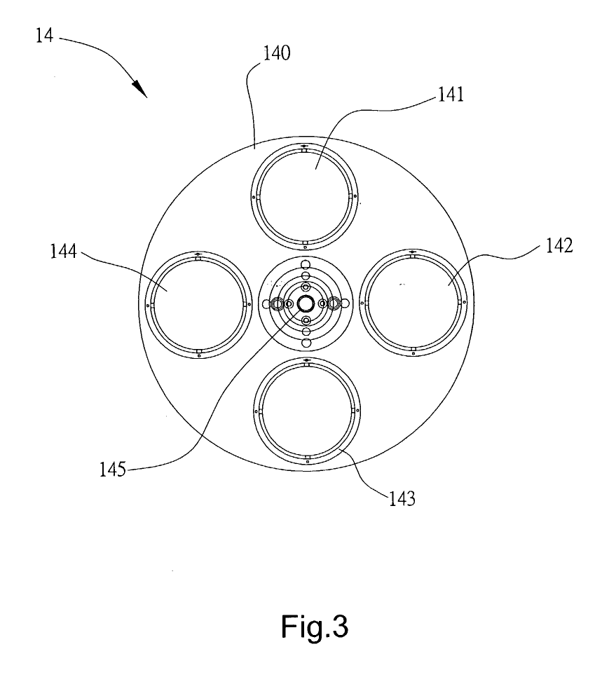

Please refer to FIG. 3. The optical module 14 includes a rotation device 140, optical lenses 141, 142, 143 and 144, and a hole 145.

In this embodiment, the rotation device 140 is a circular plate, but is not limited to this. The rotation device 140 includes a plurality of optical lenses 141, 142, 143 and 144 with different light transmission rate. In this embodiment, the optical lenses 141, 142, 143 and 144 are polarized lenses or light-subtracting lenses, but are not limited to these. The rotation device 140 has the hole 145 for receiving and supporting the pivot 161 of the driving device 16.

Please refer to FIG. 1, FIG. 2, and FIG. 3. In process of testing the automatic exposure function, the digital camera 12 is held by the holding device 13, and the view angle of lens 121 of digital camera 12 (i.e., the width range covered by the lens 121) passes through one of the optical lenses 141, 142, 143 and 144 of the optical module 14, and converges within the range of the light box 18.

To change the intensity of the light source from the light box 18 projected onto the lens 121 of the digital camera 12, the driving device 16 rotates the optical module 14. Thus, the view angle of the lens 121 passes through another optical lens of the optical module 14, for example, the optical lens 142.

Subsequently, repeat the steps described above so that the view angle of the lens 121 respectively passes through the optical lenses 143 and 144. The optical lenses 141, 142, 143 and 144 have respectively different light transmission rate and respectively provide the digital camera 12 with the different intensity of light source.

Afterwards, execution of automatic exposure function by adjusting the exposure time, gain value, aperture vale and so on, the digital camera captures images with consistent luminance effects under different intensity of light source.

In the embodiment described above, the rotation device 140 is a circular plate, but is not limited to this. The rotation device 140 also can be a square plate or a plate of other shape. Besides, the present invention is not limited to provide four optical lenses 141, 142, 143 and 144, more or less optical lenses also can be provided to achieve the aspects of the present invention.

Those skilled in the art will readily observe that numerous modifications and alterations of the devices may be made while retaining the teachings of the invention. Accordingly, the above disclosure should be construed as limited only by the metes and bounds of the appended claims.

What is claimed is:

1. A testing device for testing automatic exposure function of a camera, comprising:
a holding device for holding the camera;
a light box for providing a light source; and
an optical module disposed between the holding device and the light box for changing a light intensity of the light source projected onto the camera.

2. The testing device of claim 1 wherein the camera is a digital camera.

3. The testing device of claim 1 wherein the optical module comprises a rotation device having a plurality of optical lenses with different light transmission rates.

4. The testing device of claim 3 further comprising a driving device for driving the rotation device to rotate.

5. The testing device of claim 4 wherein the driving device comprises a servomotor.

6. A testing device for testing automatic exposure function of a camera, comprising:
a holding device for holding the camera;
a light box for providing a light source; and
an optical module disposed between the holding device and the light box for changing a light intensity of the light source projected onto the camera, the optical module comprising a rotation device having a plurality of optical lenses with different light transmission rate;
wherein the plurality of optical lenses are disposed along a circumferential direction of the rotation device.
